(19) United States
(12) Patent Application Publication
(10) Pub. No.: US 2025/0363905 A1
(43) Pub. Date: Nov. 27, 2025

(54) SYSTEM FOR TRACKING MASTERY OF A USER ON AN ONLINE LEARNING PLATFORM TO TAILOR DELIVERY OF EDUCATIONAL CONTENT

(71) Applicant: 2hr Learning, Inc., Austin, TX (US)

(72) Inventors: Philip Hewinson, Woking (GB); Samy Aboel-Nil, Austin, TX (US); Simon Said, Malta (MT); Bogdan Tenea, Bucharest (RO)

(73) Assignee: 2hr Learning, Inc., Austin, TX (US)

(21) Appl. No.: 19/218,316

(22) Filed: May 25, 2025

Related U.S. Application Data
(60) Provisional application No. 63/652,135, filed on May 27, 2024.

(51) Int. Cl. G09B 7/04; G09B 7/08

(52) U.S. Cl. CPC G09B 7/04; G09B 7/08

(57) ABSTRACT

A method of tracking mastery of a user on an online learning platform. The method includes executing code using one or more processors of a computer system to cause the computer system to perform operations include receiving inputs from the user related to selection of a topic that the user wants to study, presenting a set of questions based on educational standards related to the topic. The mastery of the user on the topic is updated in real-time based on the responses submitted by the user on the presented questions. The mastery is also displayed to the user via a graphical representation on the user interface. The educational standards are identified within a topic on which user has lowest mastery levels and receives questions stored in a database that are targeted on the unmastered standards.

### CROSS-REFERENCE TO RELATED APPLICATION

This application claims the benefit under 35 U.S.C. § 119(c) and 37 C.F.R. § 1.78 of U.S. Provisional Application No. 63/652,135, filed May 27, 2024, which is incorporated by reference in its entirety.

### FIELD OF THE INVENTION

The present invention relates in general to the field of electronics, and more specifically to a system and method for tracking mastery of a user on an online learning platform to provide educational content of corresponding mastery level.

### BACKGROUND OF THE INVENTION

Conventional educational technology has long been criticized for its one-dimensional approach to content delivery, relying mainly on static text-based materials or simplistic video lectures. These methods lacked interactivity and failed to cater to the diverse learning styles and preferences of students, resulting in decreased motivation and retention of information over time.

In an attempt to improve engagement, companies, and educational institutions began incorporating multimedia elements like images and videos into their content. However, this still didn't fully interactively engage learners. Some platforms introduced basic quizzes and flashcards, but these lacked depth and didn't provide a comprehensive learning experience. Moreover, the content wasn't tailored to individual performance, leading to a one-size-fits-all approach that could overwhelm or under-challenge students.

Traditional textbooks and lecture videos need more interactivity and personalization, potentially leading to disengagement and ineffective learning. Similarly, static online quizzes and flashcards fail to adapt to user performance and offer limited variety and depth, which may not sustain long-term engagement. One-size-fits-all e-learning platforms fail to cater to individual learning needs, risking overwhelming or under-challenging students, thus resulting in frustration or boredom.

Gamified learning apps, while introducing an element of fun, often lack content variety and risk overshadowing educational content with gamification elements, potentially leading to diminished learning outcomes. Adaptive learning systems, while promising, may not fully engage users if content types don't match their preferences, becoming predictable without innovative formats.

Historically, educational content was delivered linearly, following a set curriculum without considering individual student strengths and weaknesses. This approach could lead to information overload or insufficient challenge, as well as gaps in understanding due to a lack of tailored content. Traditional educational software and static content delivery systems do not adapt to individual student performance, potentially leading to disengagement and less personalized learning experiences. Similarly, linear progression educational models can feel repetitive and less engaging, as students must master one standard before moving to the next.

Visualizing mastery progress traditionally relies on numerical or percentage-based indicators, which may not effectively communicate progress or engage users. However, these methods may not be universally understandable, affecting user's ability to track and be motivated by their learning progress.

### SUMMARY

The present invention relates to a system and method for tracking mastery of a user on an online learning platform to provide educational content of corresponding mastery level.

In an embodiment, a method of tracking mastery of a user on an online learning platform to tailor the educational content delivery is disclosed. The method comprises executing code using one or more processors of a computer system to cause the computer system to perform multiple operations. The operations initiates with receiving inputs from the user related to the selection of a topic that the user wants to study via the online learning platform. Then, a set of questions are presented to a user via a user interface. The set of questions includes questions related to various educational standards related to the selected topic. Mastery of the user is updated on the topic in real-time based on responses submitted by the user on presented questions. The mastery is displayed to the user via a graphical representation on the user interface. Further, educational standards within a topic are identified where the user has a lowest mastery level by analyzing the user's mastery level across different standards within the topic in real-time to assess the current performance of the user on various standards and identify the unmastered standards. Finally, receiving questions that are selected from the unmastered standards or standards for which the user haven't reached the next mastery threshold.

In yet another embodiment, a system for tracking mastery of a user on an online learning platform to tailor the educational content delivery is disclosed. The system comprises one or more processors, and a memory, operatively coupled to the one or more processors consisting of one or more codes that, when executed, cause the one or more processors to perform multiple operations. The operations include receiving inputs from the user related to the selection of a topic that the user wants to study via the online learning platform. A set of questions are presented to the user via a user interface. The set of questions includes questions related to various educational standards related to the selected topic. The mastery of the user on the topic is updated based on responses submitted by the user on presented questions. The mastery is displayed to the user via a graphical representation on the user interface. The educational standards are identified within a topic where the user has a lowest mastery level by analyzing the user's mastery level across different standards within the topic in real-time to assess the current performance of the user on various standards and identify the unmastered standards. The questions are received from a database where they are stored. The questions are selected from the unmastered standards or standards that haven't reached the next mastery threshold.

### BRIEF DESCRIPTION OF THE DRAWINGS

The systems and methods described herein may be better understood, and their numerous objects, features, and advantages are made apparent to those skilled in the art by referencing exemplary embodiments depicted in the accompanying figures. The use of the same reference number throughout the several figures designates a like or similar element.

FIG. 1 depicts an exemplary user mastery tracking system while the user is using an online learning platform.

FIG. 2 depicts an exemplary user mastery tracking process while the user is using an online learning platform.

FIG. 3 depicts a flow chart showing the details of the steps involved in the user mastery tracking process while the user is using an online learning platform.

FIG. 4 depicts a flow chart for serving adaptive content to users based on their weakest standards.

FIG. 5 depicts an exemplary view of the user interface of an online learning platform, which displays one or more topics that can be selected by the user for adaptive learning.

FIG. 6 depicts an exemplary view of the user interface of an online learning platform, which displays the unit-wise progress made by the user when the user attempts the questions asked.

FIGS. 7 and 8 depict an exemplary view of the user interface of an online learning platform, which displays the unit-wise progress made by the user when the user attempts the questions asked.

FIGS. 9 and 10 depict an exemplary view of the user interface of an online learning platform where the question is in the form of a truth or a lie, and answers or learning from the real-time tutor, respectively, are provided to the user.

FIGS. 11 and 12 depict an exemplary view of the user interface of an online learning platform where the question is in the form of multiple choice questions, and answers or learning from the real-time tutor, respectively, are provided to the user.

FIG. 13 depicts an exemplary view of the user interface of an online learning platform where a real-time tutor provides adaptive learning to the user.

FIG. 14 depicts an exemplary view of the user interface of an online learning platform where the question is in the form of matching the following, and answers or learning from the real-time tutor, respectively, are provided to the user.

FIGS. 15 and 16 depict an exemplary view of the user interface of an online learning platform where the user provides correct and incorrect answers to the question asked, respectively, based on which the response is generated.

FIG. 17 depicts an exemplary view of the user interface of an online learning platform, which displays the mastery level of the user when the user answers all the questions.

FIG. 18 depicts an exemplary view of the user interface of an online learning platform, which displays the mastery level of the standard within the topic chosen when the user answers all the questions.

FIG. 19 depicts an exemplary view of the user interface of an online learning platform, which displays the mastery level of each unit when the user answers all the questions.

FIG. 20 depicts an exemplary network environment in which the system of FIG. 1 and the process of FIG. 2 may be practiced.

FIG. 21 depicts an exemplary computer system.

### DETAILED DESCRIPTION

A real-time progress tracking system to track progress of a user on an online learning platform. The progress tracking system track the interaction of the user with the displayed content to track mastery level of the user on a topic. The content item generated for the user involves the topic in which the user has a lowest mastery level. The content is made available to the user on a user interface that is integrated into an online learning platform. The online learning platform and progress tracking system are operatively coupled to each other. The online learning platform further includes a memory that stores one or more user profile details and is operatively coupled to one or more processors executing code to perform operations mentioned below.

A topic identifier integrated within the progress tracking system accesses one or more user profile details available in the user profile and fetches the user's current topic of interest. If the user has set the current topic of interest, then a selector selects the topic, and if the current topic of interest is not set by the user, then the selector selects the earliest topic having the lowest grade achieved by the user. Further, a standard identifier determines standards within the selected topic of interest that have not reached the next grade milestone and fetches content items based on the determined standards and content distribution. The standards include unmastered standards or standards below the next mastery threshold.

The mastery level identification module then identify educational standards within a topic where a “student” (may also be referred to as a “user”) has the lowest mastery levels by analyzing the user's mastery levels across different standards within the topic in real-time to assess the current performance of the user. The generated content, i.e., “question” (may also be referred to as a “content”, “generated content”, “a plurality of questions”, “content item”), is received that are stored in a database. The questions are then shared with the user on the online learning platform using a visualization module. The question is selected from unmastered standards or standards that haven't reached the next mastery threshold. The question is displayed to the user on the user interface of the online learning platform.

Along with the question, the progress made by the user is tracked during the whole process and is made available to the user using the visualization module operatively coupled to the user interface. The visualization module displays the visual progress indicators that include pie charts and progress indicators to the users. The visual indicators represent the user's mastery levels across various educational standards and topics.

The user mastery tracking system offers several significant advantages, including highly personalized learning experiences in correspondence to the individual user's performance through real-time analysis of mastery levels. Utilizing adaptive machine learning algorithms, the user mastery tracking system ensures that the users receive targeted educational materials that address their weakest areas, enhancing their overall learning efficiency. Integration of the diverse content types, such as interactive simulations, multiple-choice questions, and explanatory videos, provides various learning styles, making the learning process more engaging and effective. Additionally, intuitive visual progress indicators like pie charts and progress bars provide clear insights into the user's mastery levels, motivating them and making it easier to track their progress. Overall, the user mastery tracking system 100 provides a dynamic and responsive approach to content delivery that significantly improves educational outcomes by focusing on each user's unique needs and learning pace.

While the user mastery tracking system presented herein makes use of specific reference to dynamic, adaptive, and personalized learning for the students using a real-time tutor and tracks the progress of the student, it is to be appreciated that the description is also equally applicable for school teachers, parents teaching their child at home, the student doing self-tutoring, coaching tutors, adults learning for their career development, employees in corporate training,, children for craft, music and other education, and so on.

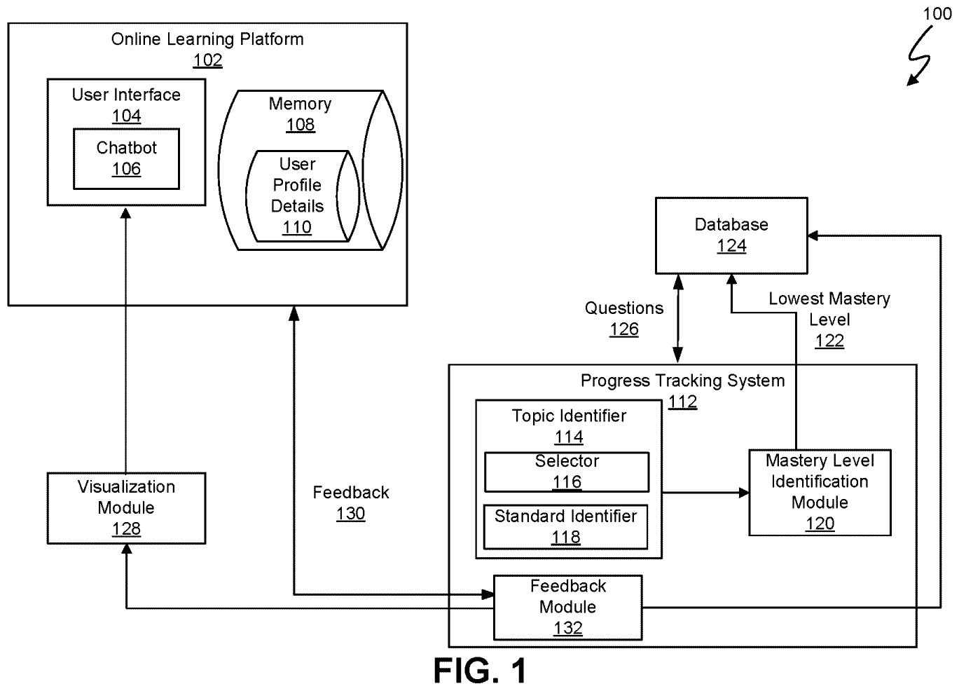

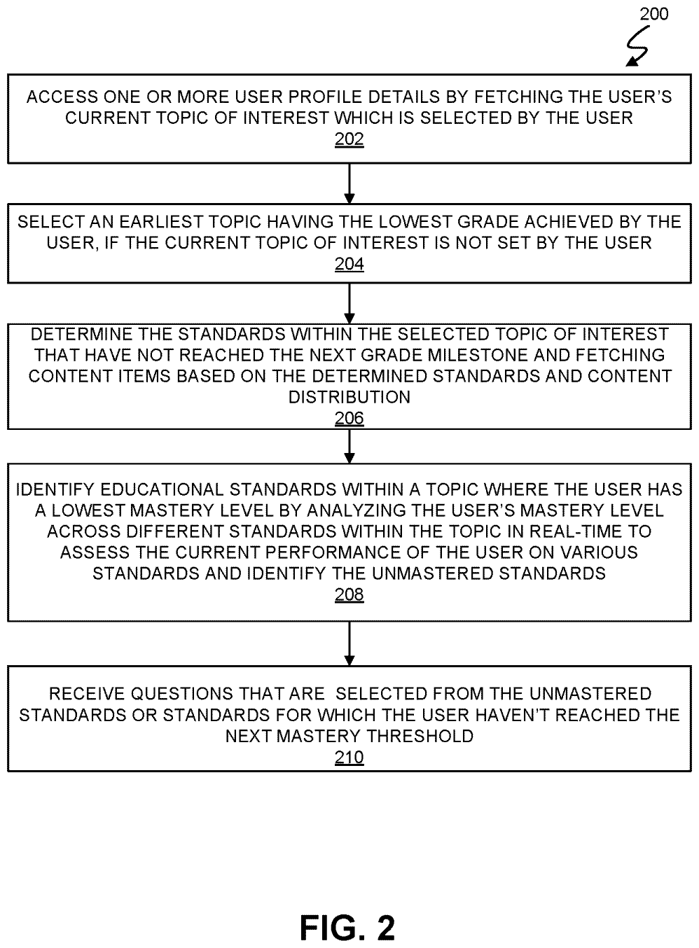

FIG. 1 depicts an exemplary user mastery tracking system 100 while the user is using an online learning platform. FIG. 2 depicts an exemplary user mastery tracking process 200 while the user is using an online learning platform utilized by the user mastery tracking system 100.

A user mastery tracking system 100 tracks the progress of the user in real-time using programmatic techniques. a progress tracking system 112 is operatively coupled to an online learning platform 102, using which the user undergoes online learning sessions which provides them adaptive and personalized learning through real-time tutors. The progress tracking system 112 which includes a topic identifier 114 to identify the user's topic of interest based on various factors which will be discussed in detail in the later section and a mastery level identification module 120 to determine the mastery level of the user, particularly lowest mastery level. The progress tracking system 112 is further coupled to a database 124 that stores a plurality of questions 126 that are provided to the user based on the mastery level of the user. The user mastery tracking system 100 further comprises memory 108 operatively coupled to one or more processors of a computer system and uses codes to execute the below-mentioned operations.

Referring to FIGS. 1 and 2, in operation 202, a topic identifier 114 accesses one or more user profile details 110, stored in the memory 108 of the online learning platform 102 for fetching the user's current topic of interest. If the user has already set the topic of interest then a selector 116 integrated within the topic identifier 114 selects the current topic of interest.

The online learning platform 102 incorporates a diverse array of content types to provide various learning styles and objectives. Firstly, academic content forms the backbone of the curriculum, offering in-depth explanations and resources directly related to the subject matter being taught. Accompanying the academic materials are non-academic resources that broaden the learning experience beyond traditional subject matter. This category encompasses content aimed at skill development, personal growth, or exploring interdisciplinary connections. For instance, users may access resources on effective study strategies, inspirational stories of scientific pioneers, or discussions on the ethical implications of biotechnology.

Furthermore, the online learning platform 102 integrates interactive content to promote active engagement and reinforce learning. Interactive elements, including virtual simulations, quizzes, and interactive diagrams, allow users to immerse themselves in the subject matter and receive immediate feedback on their understanding. Also, the inclusion of non-interactive content delivers information in a more passive format, providing valuable insights and knowledge without requiring user interaction. This category encompasses text-based resources, images, and videos that users can consume at their own pace. Whether through reading assignments, educational videos, or infographics summarizing key concepts, non-interactive content serves as a supplemental resource to reinforce understanding and provide additional context.

The online learning platform 102 further provides a diverse range of content items to accommodate various learning preferences and styles. These include multiple-choice questions, interactive simulations, fill-in-the-blank exercises, truth or lie activities, and explanatory videos. For example, users who prefer visual learning can benefit from explanatory videos that illustrate complex concepts, while those who thrive on hands-on experiences can engage with interactive simulations to deepen their understanding. Additionally, multiple-choice questions and fill-in-the-blank exercises offer opportunities for self-assessment and support key concepts. By offering a mix of interactive and static content, the online learning platform 102 ensures that users can engage with educational materials in ways that best suit their individual needs and preferences.

In operation 204, the topic identifier 114 selects an earliest topic having the lowest grade achieved by the user using the selector 116. The earliest topic is selected if the current topic of interest is not set by the user.

Fetching content items based on identified standards and content distribution involves a series of steps to ensure personalized and effective learning experiences. Firstly, standards within the topic and content distribution settings are identified. This serves as input to the mastery level identification module 120, to fetch the questions 126 from the database 124 that are aligned with the specified standards and which are in correspondence with the user's learning needs.

The questions 126 are fetched from the database 124.Subsequently, the machine learning algorithms filters and prioritizes the received questions 126 to address the lowest mastery level. By analyzing the user's performance data and mastery levels, the progress tracking system 112 identifies which standards require additional focus and ensures that the generated content targets those areas effectively.

The content provided to the user incorporates the diverse set of questions 126 covering all standards within a given topic. This approach ensures coverage of the subject matter, allowing the users to engage with various concepts and topics within the subject area. Furthermore, the content selection is dynamically adjusted based on real-time analysis, ensuring that the user receives materials that address their current learning needs and areas of weakness. By offering a mixed set of questions and broad coverage of standards, the online learning platform 102 supports effective learning and mastery of the topic at hand.

In operation 206, the standard identifier 118 determines standards within the selected topic of interest that have not reached the next grade milestone. The standard identifier 118 further fetches the content items based on the determined standards and content distribution. The standards include unmastered standards or standards below the next mastery threshold.

Prioritizing the weakest area of the user involves a systematic approach to identify and address the learning gaps effectively. Firstly, the progress tracking system 112 analyzes the user's performance data to determine which standards within the topic have the lowest mastery level. For instance, consider a student named Maria who is studying biology. The progress tracking system 112 analyzes Maria's performance on various topics and identifies that she struggles the most with understanding cellular respiration. This analysis provides valuable insights into Maria's weakest areas, guiding the next steps in content prioritization.

Secondly, the progress tracking system 112 ranks the fetched content items based on their relevance to the identified weakest standards. Content items that specifically target the concepts and skills associated with cellular respiration, such as interactive diagrams or explanatory videos, are given higher priority. By aligning the content with Maria's weakest areas, the progress tracking system 112 ensures that she receives materials that directly address her learning needs and challenges.

Lastly, the mastery level identification module 120 selects and organizes the ranked content items to ensure that those addressing the weakest areas are presented first. This means that when Maria accesses the online learning platform 102, she is immediately provided with the questions 126 focused on improving her understanding of cellular respiration. These materials are strategically presented to her, prioritizing her most challenging topics and facilitating targeted learning. As Maria engages with the content and demonstrates progress, the mastery level identification module 120dynamically adjusts the prioritization of the content item to address her evolving learning needs effectively.

Content distribution is crucial for delivering an effective and engaging learning experience to users to provide an adaptive and personalized learning experience. Firstly, the progress tracking system 112 selects content items based on unmastered standards or standards that are below the next mastery threshold. For example, let's consider a scenario where a student named David is studying mathematics. The progress tracking system 112 identifies that David struggles with understanding fractions. Therefore, progress tracking system 112 selects content items specifically focusing on fractions-related standards, such as adding and subtracting fractions, to address David's learning gaps.

Secondly, the progress tracking system 112 prioritizes academic interactive content to ensure coverage and mastery of the subject matter. This means that the majority of content items provided to users are interactive and directly related to academic concepts. For example, the progress tracking system 112 may prioritize interactive simulations or virtual manipulatives that allow David to visually explore fractions, reinforcing his understanding through hands-on practice.

Lastly, the progress tracking system 112 maintains a balance between different content types by ensuring that approximately two-thirds of content items are academic interactive, while the remaining one-third comprises varied content types. This diverse approach ensures that users like David have access to a mix of interactive exercises, explanatory videos, quizzes, and other materials. For instance, alongside interactive fraction exercises, David may also receive non-interactive resources such as explanatory videos explaining fraction concepts or fill-in-the-blank exercises to reinforce his learning.

In operation 208, the mastery level identification module 120 identifies educational standards within a topic where the user has a lowest mastery level by analyzing the user's mastery level across different standards within the topic in real-time to assess the current performance of the user on various standards and identify the unmastered standards.

The mastery level identification module 120, enhances the adaptability and effectiveness by utilizing details like user's historical performance data, user input and so on. By analyzing the user's past interactions and performance within the online learning platform 102, the mastery level identification module 120 gains valuable insights into the user's strengths and weaknesses across different subject areas and standards. For example, if a student named Jack consistently struggles with understanding geometric proofs but excels in solving algebraic equations, the mastery level identification module 120 will recognize this pattern based on Jack's historical performance data to determine the lowest mastery level of the user.

By using the historical performance data and the user input, the mastery level identification module 120 determines the user's lowest mastery level. For Jack, this might involve determining the unmastered standard or standard in which the user has not attained mastery, providing him with opportunities to practice and reinforce his understanding in this challenging area. This stimulate Jack's engagement and encourage active learning, guiding him toward mastery in the areas where he needs the most improvement.

Furthermore, by incorporating historical performance data and the user input into the mastery level identification module 120 for the identification of the lowest mastery level, the user's lowest mastery level 122 is significantly enhanced.

The mastery level identification module 122 analyzes the user's mastery level across different standards within the topic in real-time to assess the current performance of the user. The mastery level identification module 122 utilizes programmatic techniques like machine learning algorithms to analyze different standards within the topic.

The mastery level identification module 122, evaluates the user's mastery level across different standards within the topic in real-time. This assessment is vital for understanding the user's current performance and identifying areas where they may need additional support or intervention.

To analyze the user's mastery level, the mastery level identification module 122 uses advanced techniques, including natural language processing (NLP) to interpret and understand the historical data, as well as the user's responses.

The dynamic adjustment of served content is a feature that ensures users receive content in correspondence with the learning experiences of the user that evolve with the progress of the user. Firstly, the progress tracking system 112 continuously monitors the user's mastery level for each standard within the topic. For example, imagine a student named Emily studying algebra. As Emily interacts with content related to various algebraic concepts, the progress tracking system 112 tracks her performance and mastery level for each standard, such as solving equations or graphing linear functions.

Secondly, the standard identifier 118 identifies standards with the lowest mastery levels or those yet to reach the next proficiency threshold. By analyzing Emily's performance data, the progress tracking system 112 can pinpoint areas where she struggles the most or has not yet achieved mastery. For instance, if Emily consistently struggles with graphing quadratic functions, the progress tracking system 112 recognizes this as a weaker topic requiring additional focus. Based on this the mastery level identification module 122 fetches the questions 126 stored in the database 124.

The mastery level identification module 120 utilizes sophisticated machine learning techniques to continuously refine and enhance its ability to deliver personalized learning experiences to users based on ongoing performance data. Firstly, the mastery level identification module 120 employs a pre-trained machine learning algorithms that analyzes patterns in the user's interactions and predicts their mastery level and learning progress. The mastery level identification module 120 utilizes historical performance data to identify trends and patterns in the user's learning behavior, enabling it to make accurate predictions about their current level of mastery and progress.

The machine learning algorithms is updated in real-time based on the user's new performance data. As users engage with the online learning platform 102 and interact with the questions 126, their actions and outcomes are continuously fed back into the mastery level identification module 120.

This algorithm ensures that the questions 126 served to the user is always aligned with their current mastery level and learning needs.

Furthermore, the progress tracking system 112 incorporates a feedback module 132 where the user's interactions with the served questions 126 are analyzed and used to enhance future content generation recommendations. This feedback module 132 captures various metrics such as performance on questions, time spent on tasks, and engagement levels, which are then used to refine the machine learning algorithms predictions and improve the relevance and effectiveness of the content served to the user. By leveraging advanced machine learning techniques and a continuous feedback 130, the mastery level identification module 120 ensures that the questions 126 provided to users is dynamically tailored to their learning journeys, maximizing their learning outcomes and overall experience on the online learning platform 102.

The feedback module 132 serves as an integral component of the online learning platform 102, offering real-time feedback 130, including, insights and encouragement to users as they progress through their learning journey. Firstly, the feedback module 132 provides updates on the user's mastery level, offering valuable feedback on their performance and progress. For instance, if a student named George completes a set of practice questions on trigonometry, the feedback module 132 may inform him that he has improved her mastery level in trigonometric functions from basic to intermediate, motivating her to continue her efforts.

In addition to mastery level updates, the feedback module 132 delivers encouragement messages to the user, nurturing a positive learning environment and promoting engagement. These messages are in correspondence to the user's achievements and milestones, providing praise and motivation to keep them motivated and focused on their learning goals. For example, after completing a challenging assignment on calculus, the feedback module 132 may congratulate the user on their perseverance and commend them for their dedication to mastering difficult concepts.

Furthermore, the feedback module 132 ensures that feedback 130 is delivered in real-time, providing timely and relevant information to users as they engage with the online learning platform 102. This real-time feedback 130 mechanism enables users to track their progress instantly, receive immediate recognition for their achievements, and stay motivated throughout their learning journey.

A visualization module 128 operatively coupled to the progress tracking system 112 receives the questions 126 from the database 124. The visualization module 128 displays the user performance on the user interface 104 of the online learning platform 102. The visualization module 128 provides users with clear and informative insights into their learning progress. By displaying visual progress indicators such as pie charts and progress bars, the visualization module 128 offers users a overview of the mastery levels of the user across various educational standards and topics. For example, imagine a student named Alex using an online learning platform 102 to study chemistry. The visualization module 128 presents Alex with a pie chart that visually represents his mastery levels in different chemistry topics, such as atomic structure, chemical reactions, and stoichiometry. Each section of the pie chart corresponds to a specific topic, with the size of the segment indicating Alex's level of mastery. Additionally, progress bars may be used to show the level of completion or mastery within each topic, providing a more detailed breakdown of Alex's progress.

Through these visual representations, Alex can easily track his learning journey, identify areas where he has achieved mastery, and pinpoint topics that require further attention. For instance, if Alex notices that his mastery level in chemical reactions is lower compared to other topics, he can focus his study efforts on that specific area. Furthermore, the visualization module allows Alex to monitor his progress over time, observing how his mastery levels evolve and improve with continued study and practice.

Overall, the visualization module 128 enhances the user experience by providing intuitive and accessible visualizations of mastery progress. By presenting information in a clear and visually engaging manner, the visualization module 128 empowers users like Alex to take control of their learning and make informed decisions about their study priorities and strategies.

The pseudo-code for the ‘user mastery tracking system 100’ is given below:
#Pseudo-code for Adaptive Learning Algorithm #
Function to serve content based on the weakest standards for a student
function serveAdaptiveContent (user_id):
   #Fetch the user's current topic, if any
   current_topic=getCurrentTopic (user_id)
   #If the current topic is not set, find the earliest topic with the lowest grade
   if current_topic is null:
      current_topic=findEarliestTopicWithLowestGrade (user_id)
   #Fetch the standards within the current topic that have not reached the next grade milestone
   standards_to_cover=getStandardsNotAtNextMilestone (current_topic)
   #Fetch content items based on the standards to cover and the content distribution
   content_items=getContentItems (standards_to_cover)
   #Serve the content items to the user
   return content items
#Helper function to get the current topic for the user
function getCurrentTopic (user_id);
   #Retrieve the current topic from the database
   #Reference to the codebase: Store the user's “current topic”
   return database.getCurrentTopic (user_id)
#Helper function to find the earliest topic with the lowest grade achieved so far
function findEarliestTopicWithLowestGrade (user_id):
   #Perform a breadth-first search through all the topics
   #Reference to the codebase: Perform a breadth-first search through all the Topics
   return breadthFirstSearch (user_id)
#Helper function to get standards within a topic that have not reached the next grade milestone
function getStandardsNotAtNextMilestone (topic_id):
   #Query the database for standards within the topic that are below the next grade milestone
   #Reference to the codebase: Uniformly covers all standards in the Topic that have not yet reached the next grade milestone
   return database.getStandardsBelowNextMilestone (topic_id)
#Helper function to fetch content items based on standards and content distribution
function getContentItems (standards_to_cover):
   #Use the Content Gen API to fetch new content
   #Reference to the codebase: Content Gen API
   return contentGenAPI.fetchContent (standards_to_cover)
#Call the function to serve adaptive content to a user adaptive_content=serveAdaptiveContent (user_id)

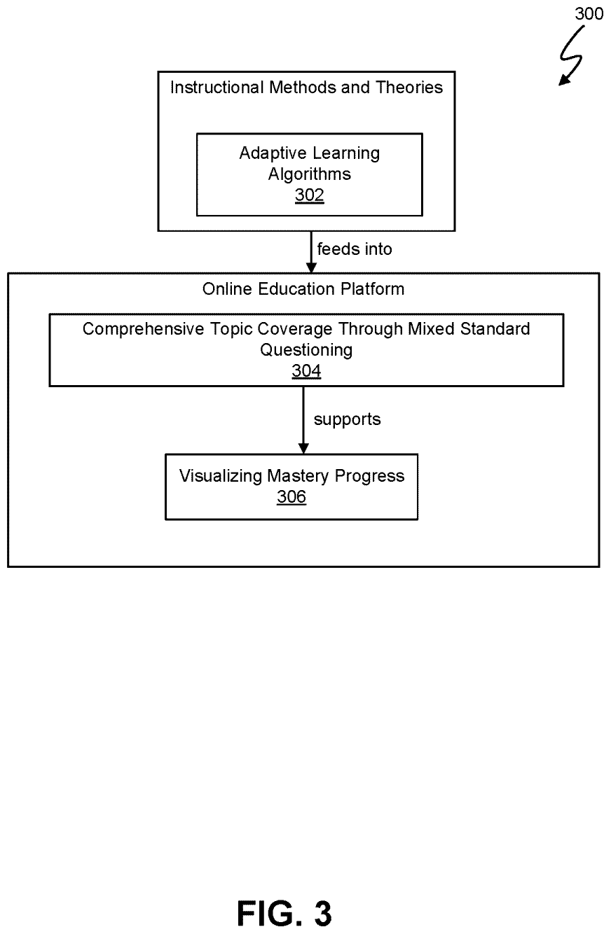

FIG. 3 depicts a flow chart showing the details of the steps involved in the user mastery tracking process while the user is using an online learning platform.

The flowchart 300 explains the process of generation of the educational content in correspondence with the performance of individual students. The process begins by using adaptive learning algorithms 302 designed to analyze and interpret a user's performance data. By doing so, the adaptive learning algorithm 302 identifies specific areas where the user exhibits the lowest levels of mastery. This data-driven approach ensures that the educational content provided is personalized and directly addresses the user's weakest points, optimizing the learning process for efficiency and effectiveness.

Building on this, the user mastery tracking system 100 employs a comprehensive topic coverage 304 method through mixed standard questioning which ensures that the user is exposed to a diverse range of questions within a topic, covering all relevant standards. The mixed standard questioning technique not only reinforces learning by increasing focus on weaker areas but also ensures that the student achieves a balanced understanding across the entire topic. This approach guarantees comprehensive coverage and helps solidify the user's grasp of various concepts, which is crucial for advancing their mastery.

Furthermore, the user mastery tracking system 100 enhances the learning experience through effective visualization of mastery progress 306 using a visualization module 136 which provides intuitive graphical representations, such as pie charts and circular progress indicators, that visually depict the user's progress. These visual tools make it easier for users to track their learning journey, understand their current standing, and identify areas needing improvement. The clear and motivating visual feedback supports ongoing engagement and helps maintain the user's motivation by showing tangible progress over time.

The interplay between these components, adaptive learning algorithms 302, comprehensive topic coverage 304, and mastery progress visualization 306 creates a robust online educational platform 102. The adaptive learning algorithms 302 feed into the comprehensive topic coverage 304 methods, ensuring that the content delivery is constantly adjusted based on real-time performance data. In turn, this comprehensive approach supports the visualization of mastery progress 306, providing students with clear, actionable insights into their learning trajectory. The integration of components not only enhances the learning experience by making it more personalized and responsive but also ensures that users are continually guided toward achieving their educational goals efficiently.

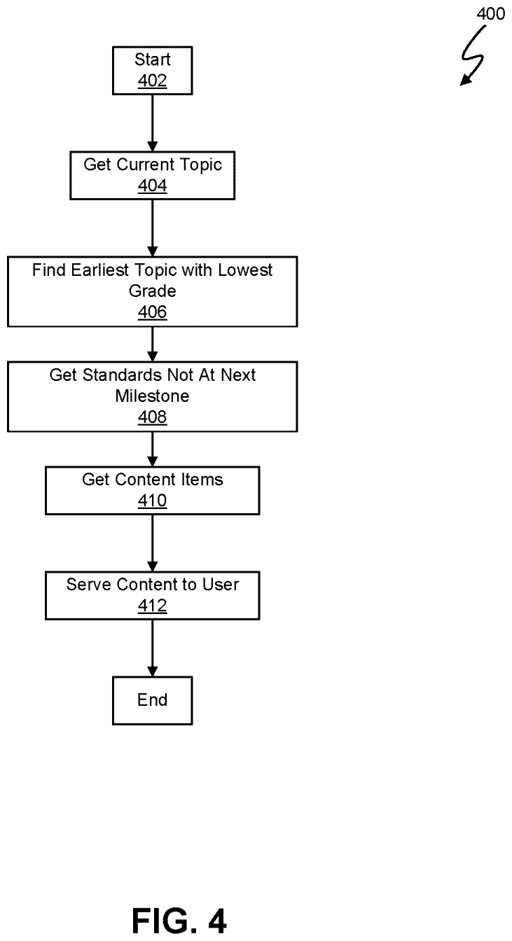

FIG. 4 depicts a flow chart 400 for serving adaptive content to users based on their weakest standards.

The flowchart 400 describes an adaptive learning mechanism designed to personalize educational content delivery based on individual student performance. The process begins by accessing the user's profile 402 to retrieve the current topic of interest 404. This step ensures that the content is relevant to the user's immediate learning goals. If the user has not set a current topic 406, the topic identifier 114 then identifies the earliest topic in which the user has achieved the lowest grade. This selection process ensures that the most critical areas are targeted where the user needs improvement, thereby maximizing the effectiveness of the learning experience.

Once the appropriate topic is identified, the standard identifier 118 fetches the educational standard 408 within that topic that has not yet reached the next grade milestone. This involves determining specific learning objectives or competencies that the user has not yet mastered. By focusing on these unmastered standards, the progress tracking system 112 ensures that the content delivered is highly targeted and relevant to the user's learning needs. This granular approach allows for a more detailed understanding of the user's weaknesses and provides a structured path for improvement.

The progress tracking system 112 then retrieves content items 410 based on these identified standards. These content items can include a variety of educational materials such as multiple-choice questions, interactive simulations, fill-in-the-blanks, truth or lie, and explanatory videos. The content is generated in correspondence to address the specific standards that the user needs to master, ensuring that the user is presented with materials that are most likely to help them improve. The ability to progress tracking system 112 fetch and deliver content in real-time allows for a highly dynamic and responsive learning experience, where the content adapts continuously based on the user's performance.

Finally, the selected content items are served to user 412 through the online learning platform 102. As the user interacts with this content using a user interface 104 integrated within the online learning platform 102, their responses are monitored and analyzed to update their mastery status in real-time. This continuous feedback loop allows the progress tracking system 112 to adjust the content dynamically, always focusing on the user's weakest areas. Additionally, the progress tracking system 112 provides intuitive visualizations using a visualization module 128 of the user's progress, such as pie charts and circular indicators, making it easy for users to track their learning journey and stay motivated. By offering a personalized and adaptive learning experience, the progress tracking system 112 ensures that users can efficiently and effectively achieve their educational goals.

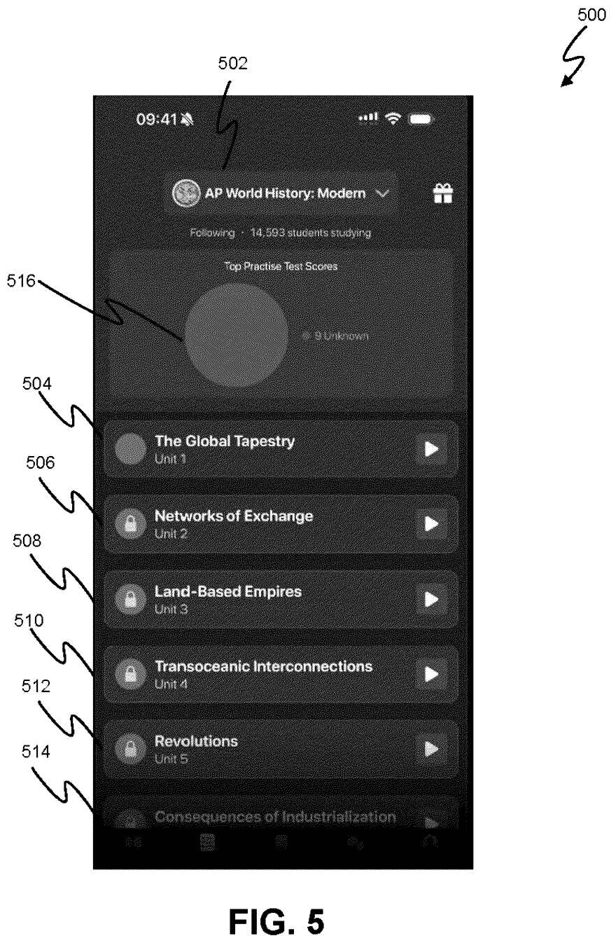

FIG. 5 depicts an exemplary view of the user interface 500 of an online learning platform 102, which displays one or more topics that can be selected by the user for adaptive learning.

The user interface 500 is accessed by the user using the online learning platform 102 installed on the user device, which may include a smartphone, tablet, computer, laptop, palmtop, or any other similar device compatible with the online learning platform 102. The user interface 500 includes tab 502 ‘AP World History: Modern’, which depicts the use of ‘AP’ curriculum and ‘Subject’ as ‘World History: Modern’. Further, the tabs 504, 506, 508, 510, 512, and 514 represent different standards within the curriculum. For instance, tab 504 represents ‘The Global Tapestry’, tab 506 represents ‘Networks of Exchange’, tab 508 represents ‘Land-based Empires’, tab 510 represents ‘Transoceanic Interconnections’, tab 512 represents ‘Revolutions’, tab 514 represents ‘Consequences of Industrialization’, and so on. This is just an exemplary scenario where the user is studying History lessons from the AP curriculum. The user can choose other subjects as well as other curriculums as well like ‘Common Core’, ‘NGSS’, and so on.

Further, the circle 516 in the middle of the user interface 500 represents the progress made by the user. Since the user interface 500 shows the user has just opened the online learning platform 102 and has not attempted any questions yet on any topic, that's why it is empty. As soon as the user starts answering questions, circle 516 displays the progress made by the user in the form of a pie chart, in which the percentage of topics mastered by the user is highlighted with a different color.

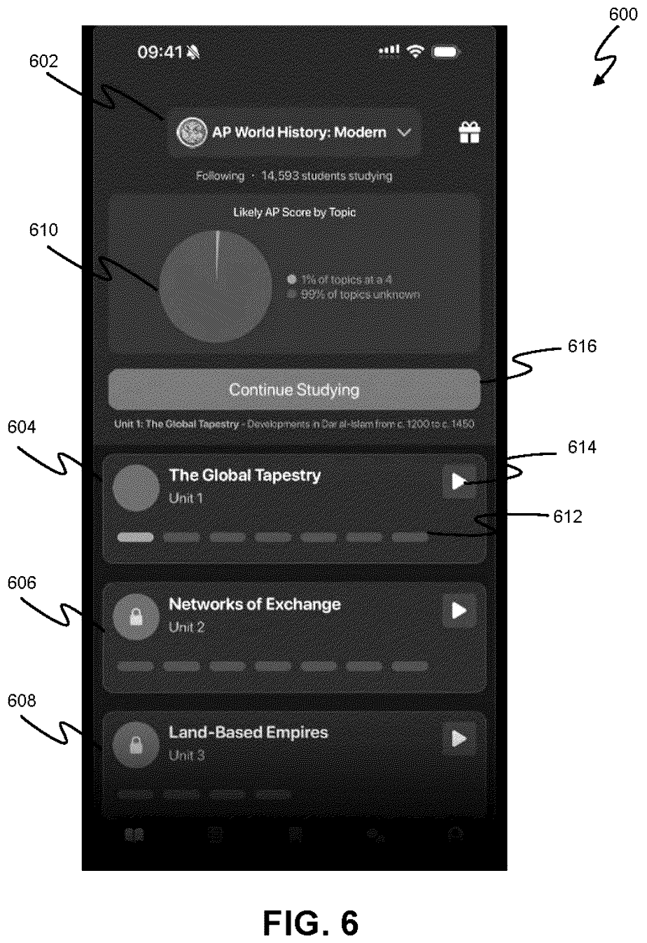

FIG. 6 depicts an exemplary view of the user interface 600 of an online learning platform 102, which displays the unit-wise progress made by the user when the user attempts the questions asked.

The user interface 600 is accessed by the user using the online learning platform 102 installed on the user's device. The user interface 600 includes tab 602 ‘AP World History: Modern’, which depicts the use of the ‘AP’ curriculum and ‘Subject’ as ‘World History: Modern’. Further, the tabs 604, 606, and 608 represent different standards within the curriculum. For instance, tab 604 represents ‘The Global Tapestry’, tab 606 represents ‘Networks of Exchange’, tab 608 represents ‘Land-based Empires’, and so on. This is just an exemplary scenario where the user is studying History lessons from the AP′ curriculum. The user can choose other subjects as well as other curriculums as well like ‘Common Core’, ‘NGSS’, and so on.

Further, the circle 610 in the middle of the user interface 600 represents the progress made by the user. The circle 610 displays the progress made by the user in the form of a pie chart, in which the percentage of topics mastered by the user is highlighted with a different color. The tab 604 ‘The Global Tapestry’, tab 606 ‘Networks of Exchange’, and tab 608 ‘Land-based Empires’ represent units that have various topics within them. As the user has completed the questions from the first topic of the first unit i.e. ‘The Global Tapestry’ by clicking on tab 604, the progress made by the user is visible on the circle 610 and the tab 612 which depicts ‘Topics’ under every unit.

Tab 614 allows the user to access a particular unit, clicking on which the user can access the topics within that unit. Tab 604 also represents the topic-wise progress made by the user, in which the topics finished by the user are highlighted with different colors. In the case of the present example, the user has finished the first topic of the first unit, so tab 604 shows one topic highlighted with a dark color. Also, by clicking on tab 616, users can continue studying the same topic or a different topic of his or her choice.

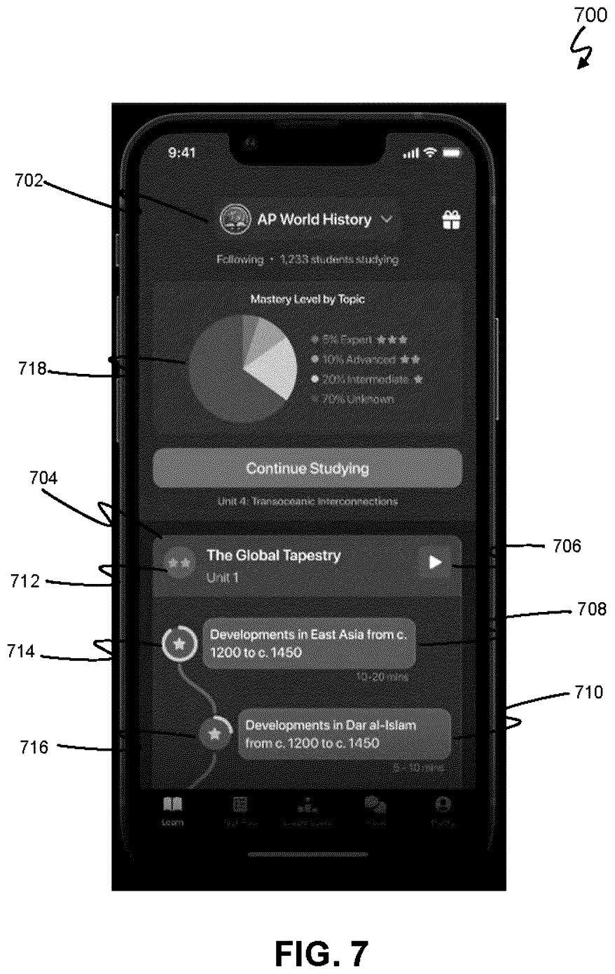

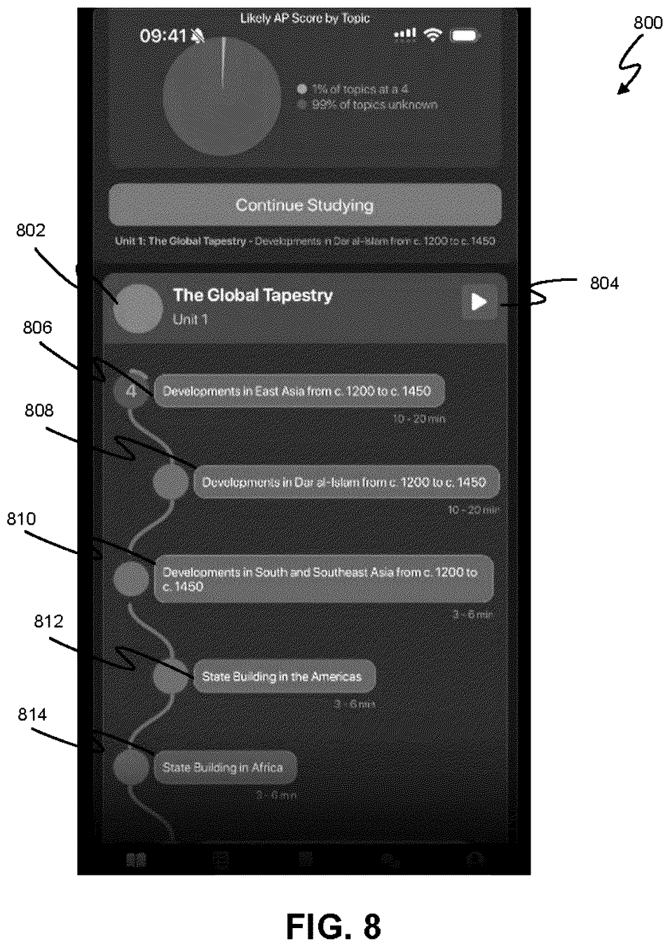

FIGS. 7 and 8 depict an exemplary view of the user interface of an online learning platform 102, which displays the unit-wise progress made by the user when the user attempts the questions asked.

The user interfaces 700 and 800 are accessed by the user using the online learning platform 102 installed on the user's device.

The user interface 700 includes a tab 702 ‘AP World History: Modern’ which depicts the use of the ‘AP’ curriculum and ‘Subject’ as ‘World History: Modern’. Tab 704 ‘The Global Tapestry’ represents the unit with multiple topics. By clicking on tab 706, the user has accessed the first unit. The first unit includes multiple topics like 708 ‘Development in East Asia from c. 1200 to c. 1450’, 710 ‘Development in Dar-al-Islam from c. 1200 to c. 1450’, and so on. The circle with stars 712 inside tab 704 ‘The Global Tapestry’ indicates the unit-wise mastery attained by the user, which is ⅖ in the case of the present example. Similarly, the circle with stars 714 and 716 inside tab 708 ‘Development in East Asia from c. 1200 to c. 1450’, and 710 ‘Development in Dar-al-Islam from c. 1200 to c. 1450’ indicates the unit-wise mastery attained by the user, which is ⅕ in the case of the present example. Further, the circle 718 in the middle of the user interface 700 represents the progress made by the user. The circle 718 displays the progress made by the user in the form of a pie chart, in which the percentage of topics mastered by the user is highlighted with a different color. Also, the circle 718 represents the mastery of the user in an explained manner like in how many topics the user has attained mastery (in percentage form and by giving stars), in how many topics the user is at advanced or intermediate level, and so on making it more engaging and useful for the user to understand his/her expertise and mastery level in the particular subject.

In user interface 800, tab 802, ‘The Global Tapestry’ represents the unit with multiple topics. By clicking on tab 804, the user has accessed the first unit. The first unit includes multiple topics like 806 ‘Development in East Asia from c. 1200 to c. 1450’, 808 ‘Development in Dar-al-Islam from c. 1200 to c. 1450’, 810 ‘Development in South and Southeast Asia from c. 1200 to c. 1450’ 810 ‘State Building in America’, 812 ‘State Building in Africa’, and so on. By clicking on any of these topics the user can access them and get the adaptive and personalized learning experience.

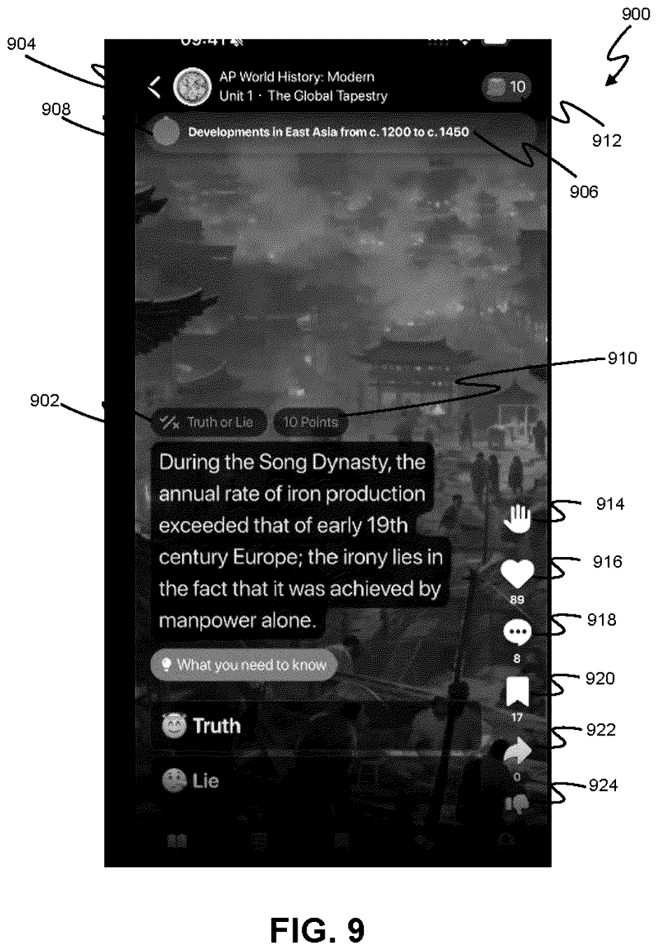

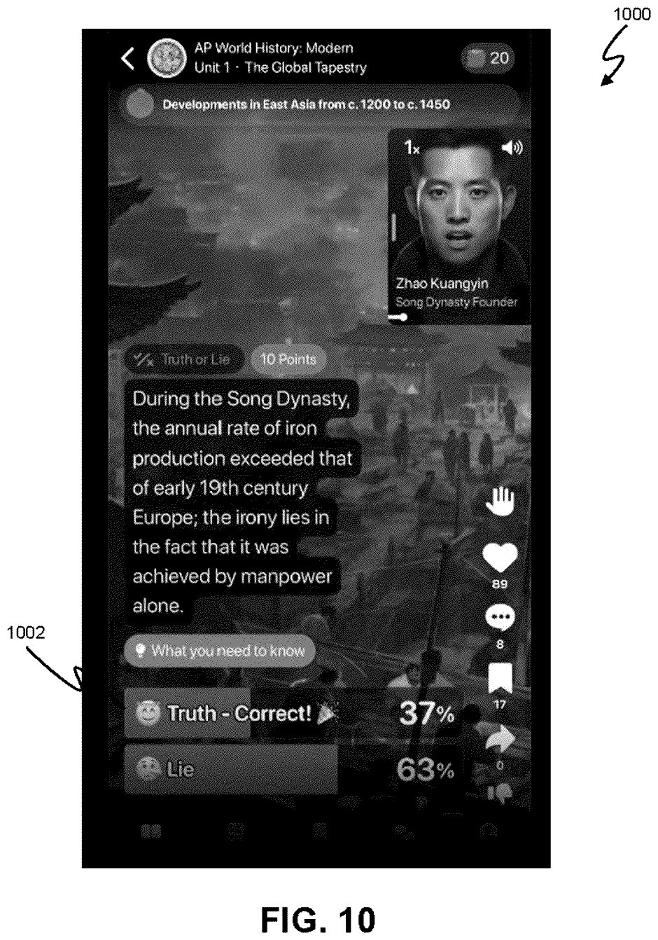

FIGS. 9 and 10 depict an exemplary view of the user interface of an online learning platform where the question is in the form of a truth or a lie, and answers or learning from the real-time tutor, respectively are provided to the user.

The user interfaces 900 and 1000 are accessed by the user using the online learning platform 102 installed on the user's device.

In user interface 900 a truth or lie question 902 is displayed to the user, which is to be answered by the user. Tab 904 discloses the details of the curriculum, subject, and unit. For example, in this case, it is the ‘World History: Modern’ subject from the ‘AP’ curriculum where the unit is ‘The Global Tapestry’. Tab 906 represents the topic of the selected unit ‘Developments in East Asia from c. 1200 to c. 1450’. The user will receive questions related to this topic only. The circle 908 beside the topic tab 906 represents how much part of the topic is completed by the user. Further, the truth or the lie question tab 902 represents the type of question, i.e., ‘Truth or Lie’, and tab 910 represents the total number of points allocated to this question, i.e., ‘10 points’. If the user answers correctly, the user gets 10 points, which are collated in the total collection shown on the top-right side of the user interface. The tab 912 represents total points collected by the user.

Further, the user can click the tab 914 ‘hand button’ to interact with the real-time tutor using a chatbot 106. The user gets a real-time answer from the tutor about the queries asked by the user. The real-time tutor uses the curriculum data, and pre-stored data to provide the details of the questions asked by the user. Also, the user can like, comment, save, share, and dislike the information provided by the real-time tutor using the tabs 916, 918, 920, 922, and 924 respectively.

In user interface 1000, the user has given a correct answer by clicking on ‘Truth’ tab 1002. Since the question asked is an academic-interactive question so the allocated points of the questions add to the total points of the user making it 20. Further, the real-time tutor provides information related to the question to the user.

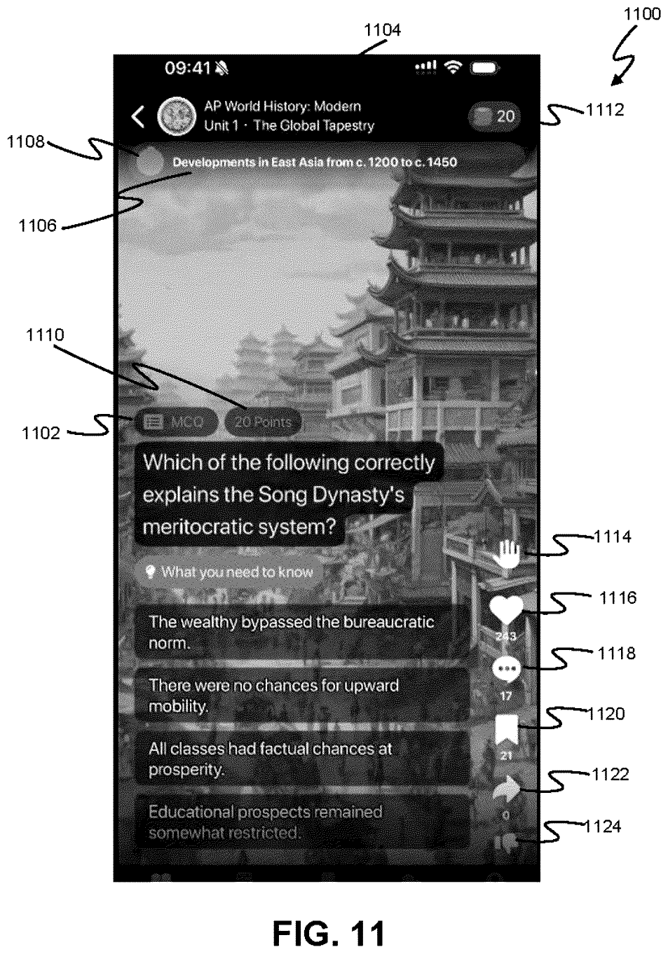

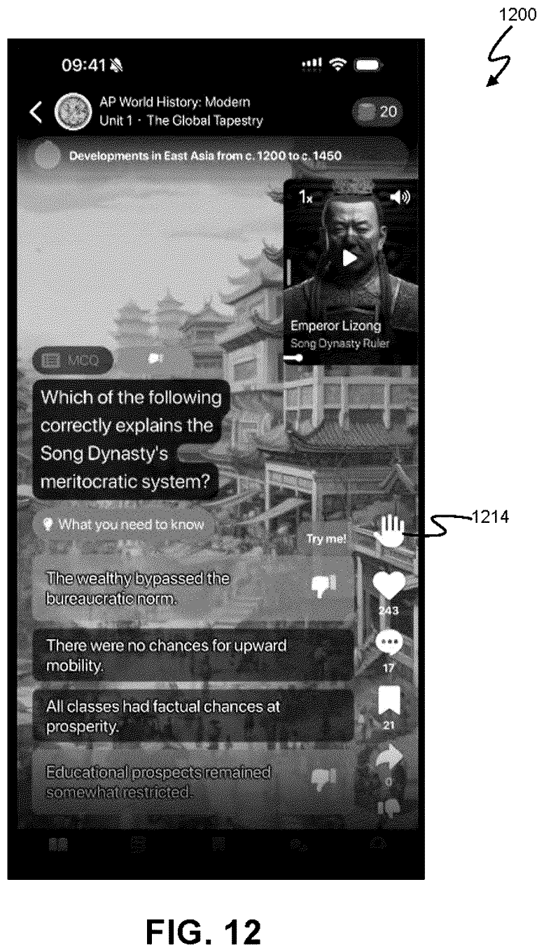

FIGS. 11 and 12 depict an exemplary view of the user interface of an online learning platform where the question is in the form of multiple choice questions, and answers or learning from the real-time tutor respectively is provided to the user.

The user interfaces 1100 and 1200 are accessed by the user using the online learning platform 102 installed on the user's device.

In the user interface 1100, multiple-choice questions (MCQ) 1102 are displayed to the user, which is to be answered by the user. Tab 1104 discloses the details of the curriculum, subject, and unit. For example, in this case, it is the ‘World History: Modern’ subject from the ‘AP’ curriculum, where the unit is ‘The Global Tapestry’. Tab 1106 represents the topic of the selected unit ‘Developments in East Asia from c. 1200 to c. 1450’. The user will receive questions related to this topic only. The circle 1108 besides the topic tab 1106 represents how much part of the topic is completed by the user. Further, the MCQ tab 1102 represents the type of question i.e., ‘MCQ’, and tab 1110 represents the total number of points allocated to this question i.e., ‘20 points’. If the user answers correctly, the user gets 20 points, which are collated in the total collection shown on the top-right side of the user interface. The tab 1112 represents total points collected by the user.

Further, the user can click the tab 1114 ‘hand button’ to interact with the real-time tutor using a chatbot 106. The user gets a real-time answer from the tutor about the queries asked by the user. The real-time tutor uses the curriculum data, and pre-stored data to provide the details of the questions asked by the user. Also, the user can like, comment, save, share, and dislike the information provided by the real-time tutor using tabs 1116, 1118, 1120, 1122, and 1124 respectively.

In user interface 1200, the user has given a wrong answer by clicking on the wrong option. Since the user gave the wrong answer, the total points of the user remain the same i.e., 20. Further, the real-time tutor provides information related to the question to the user. Also, if the user still faces queries related to the question, the user can click on the tab 1214 ‘hand button’ to chat with the real-time tutor in real-time and get his/her doubts cleared.

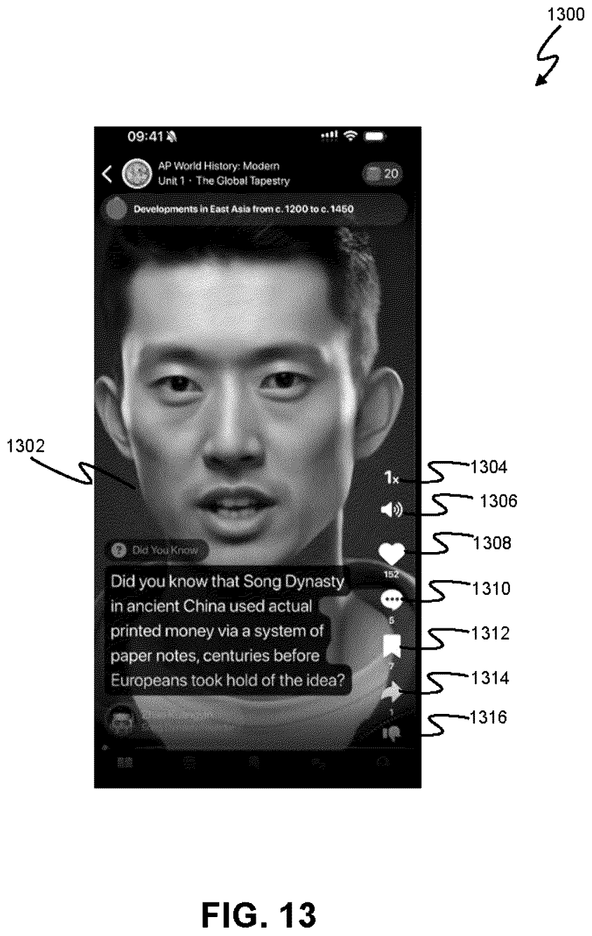

FIG. 13 depicts an exemplary view of the user interface 1300 of an online learning platform 102 where a real-time tutor provides adaptive learning to the user.

The user interface 1300 is accessed by the user using the online learning platform 102 installed on the user's device. The user interface 1300 represents a real-time tutor 1302 generated by AI for providing adaptive and personalized learning to the student. The real-time tutor 1302 is generated in correspondence to the question provided to the user. For instance, if the question is related to a physics topic, say gravity, then Issac Newton or Albert Einstein may act as a real-time tutor 1302 and provide the information related to the question to the user. The information provided by the real-time tutor 1302 is in a video format and is pre-generated.

In the user interface 1300, the user is provided with an interactive question to maintain the engagement level of the user. The user can increase the speed of the video by clicking on tab 1304, and pause the sound of the video by clicking on tab 1306. Furthermore, the user can like, comment, save, share, and dislike the information provided by the real-time tutor 1302 using the tabs 1308, 1310, 1312, 1314, and 1316 respectively.

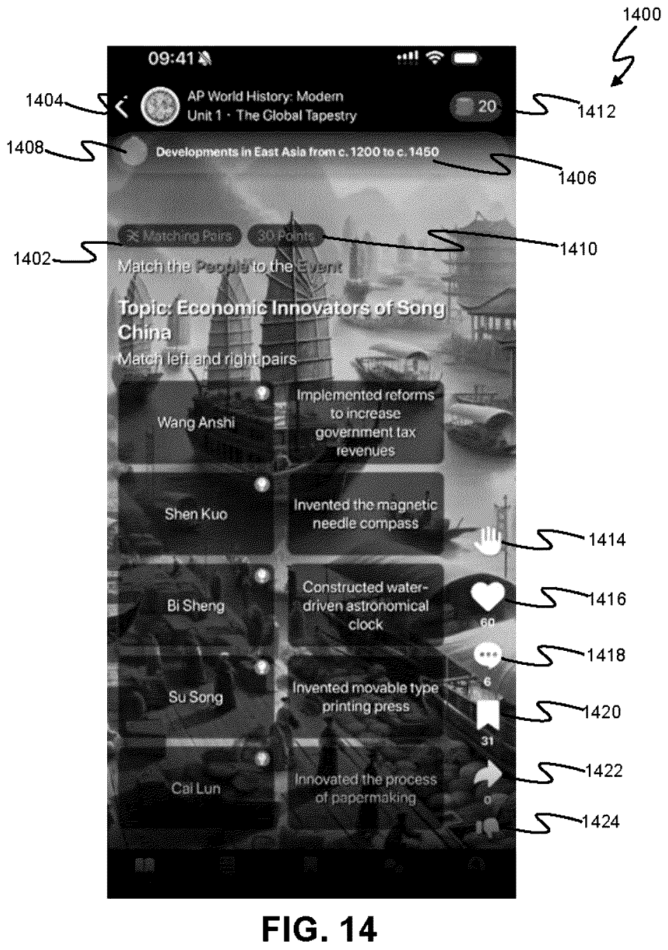

FIG. 14 depicts an exemplary view of the user interface of an online learning platform where the question is in the form of matching the following and answers or learning from the real-time tutor respectively is provided to the user.

The user interface 1400 is accessed by the user using the online learning platform 102 installed on the user's device. In user interface 1400 a match the following question tab 1402 is displayed to the user, which is to be answered by the user. Tab 1404 discloses the details of the curriculum, subject, and unit. For example, in this case, it is the ‘World History: Modern’ subject from the ‘AP’ curriculum where the unit is ‘The Global Tapestry’. Tab 1406 represents the topic of the selected unit ‘Developments in East Asia from c. 1200 to c. ‘1450’. The user will receive questions related to this topic only. The circle 1408 beside the topic tab 1406 represents how much part of the topic is completed by the user. Further, tab 1402 represents the type of question i.e., ‘Matching Pairs’ and tab 1410 represents the total number of points allocated to this question i.e., ‘30 points’. If the user answers correctly the user gets 30 points which gets collated in the total collection shown on the top-right side of the user interface. The tab 1412 represents total points collected by the user.

Further, the user can click the tab 1414 ‘hand button’ to interact with the real-time tutor using a chatbot 106. The user gets a real-time answer from the tutor about the queries asked by the user. The real-time tutor uses the curriculum data, and pre-stored data to provide the details of the questions asked by the user. Also, the user can like, comment, save, share, and dislike the information provided by the real-time tutor using tabs 1416, 1418, 1420, 1422, and 1424 respectively.

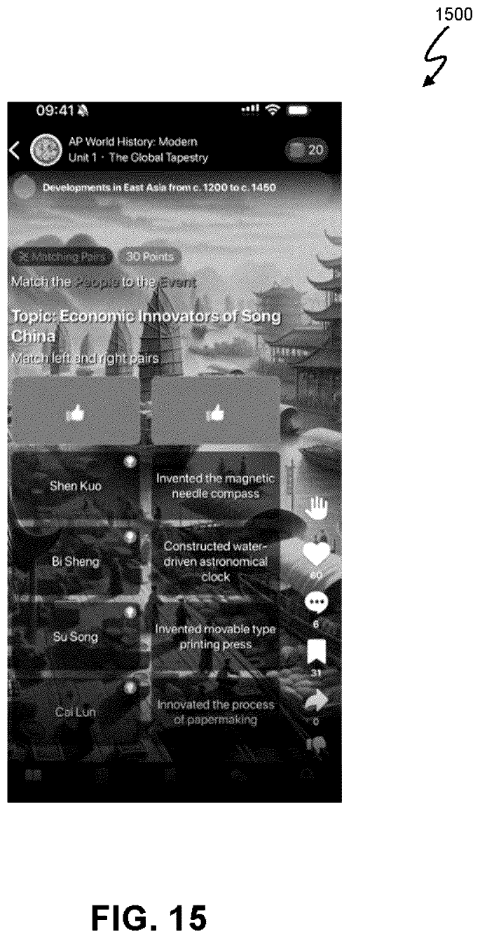

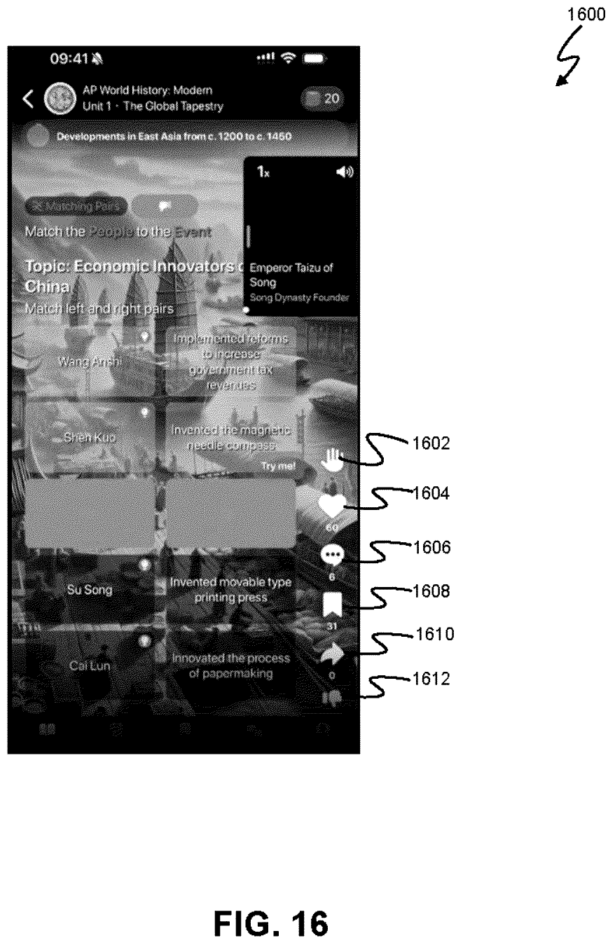

FIGS. 15 and 16 depict an exemplary view of the user interface of an online learning platform where the user provides correct and incorrect answers to the question asked respectively based on this the response is generated.

The user interfaces 1500 and 1600 are accessed by the user using the online learning platform 102 installed on the user's device.

The user interface 1500 displays that the user has given a correct answer for which 30 points will be allotted to the user which will get added to the user's total points.

The user interface 1600 displays that the user has given an incorrect answer so a video is automatically generated in which a real-time tutor provides detailed information to the user about the question asked. Further, the user can click on the hand button 1602 and chat with the real-time tutor for better clarity.

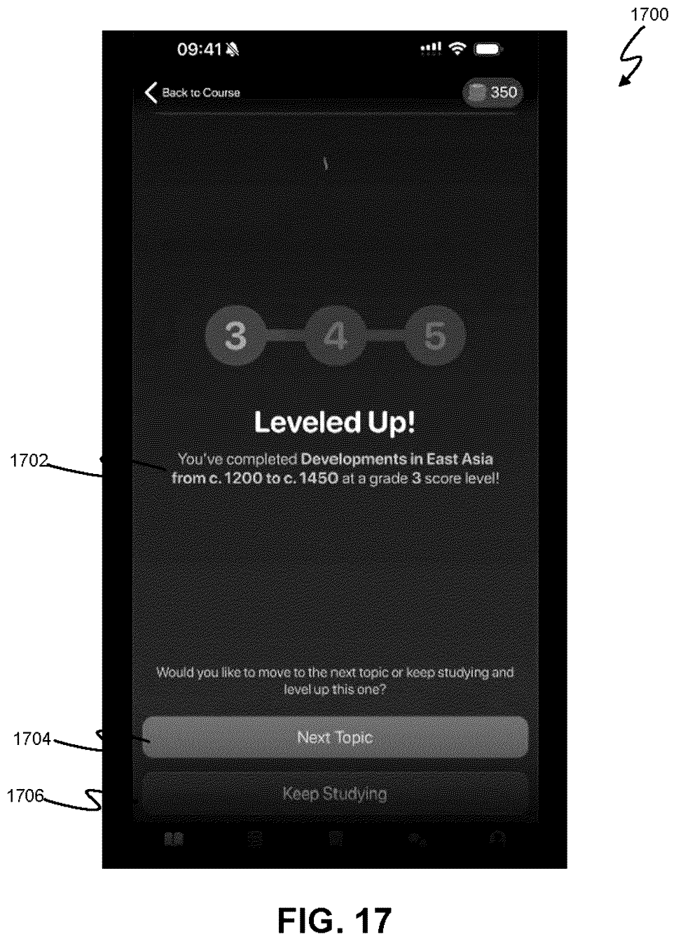

FIG. 17 depicts an exemplary view of the user interface 1700 of an online learning platform 102 which displays the mastery level of the user when the user answers all the questions.

The user interface 1700 is accessed by the user using the online learning platform 102 installed on the user's device. After completing all the questions given to the user on the particular topic, a message is displayed to the user on the user interface 1700 which indicates the mastery level the user attained by answering all the questions on the selected topic. Tab 1702 also shows a message congratulating the user that ‘you have completed Development in East Asia from c. 1200 to c. 1450 at a grade three score level!!’. After completing this the user can either click on tab 1704 ‘Next Topic’ using which the user will be given a choice to select the topic or unit of his/her choice or tab 1706 ‘Keep Studying’ using which the next topic of the same unit will appear.

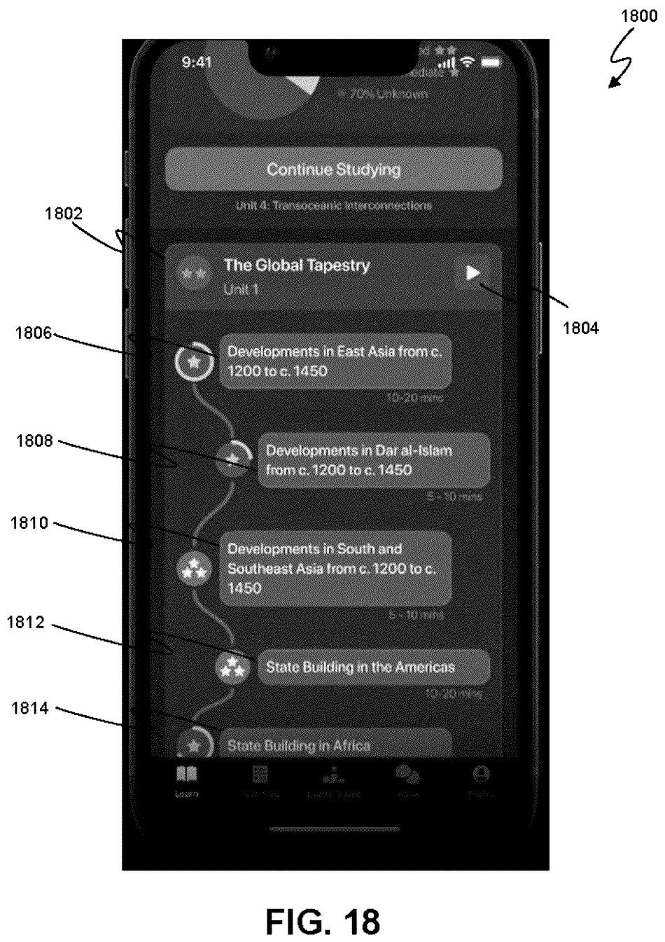

FIG. 18 depicts an exemplary view of the user interface 1800 of an online learning platform 102 which displays the mastery level of the standard within the topic chosen when the user answers all the questions.

The user interface 1800 is accessed by the user using the online learning platform 102 installed on the user's device.

As soon as the progresses on its journey towards mastering a subject by answering the questions from each topic, the user interface 1800 indicates the unit-wise and topic-wise progress made by the user and the mastery level of the user in that particular unit and topic. For example, tab 1802 ‘The Global Tapestry’ represents the unit with multiple topics. By clicking on tab 1804 the user has accessed the first unit. The first unit includes multiple topics like 1806 ‘Development in East Asia from c. 1200 to c. 1450’, 1808 ‘Development in Dar-al-Islam from c. 1200 to c. 1450’, 1810 ‘Development in South and Southeast Asia from c. 100 to c. 1450’, 1812 ‘State Building in America’, 1814 ‘State Building in Africa’, and so on.

The circle with the star inside the unit and topic tabs indicates the unit-wise and topic-wise progress made by the user respectively after answering all the questions provided to the user.

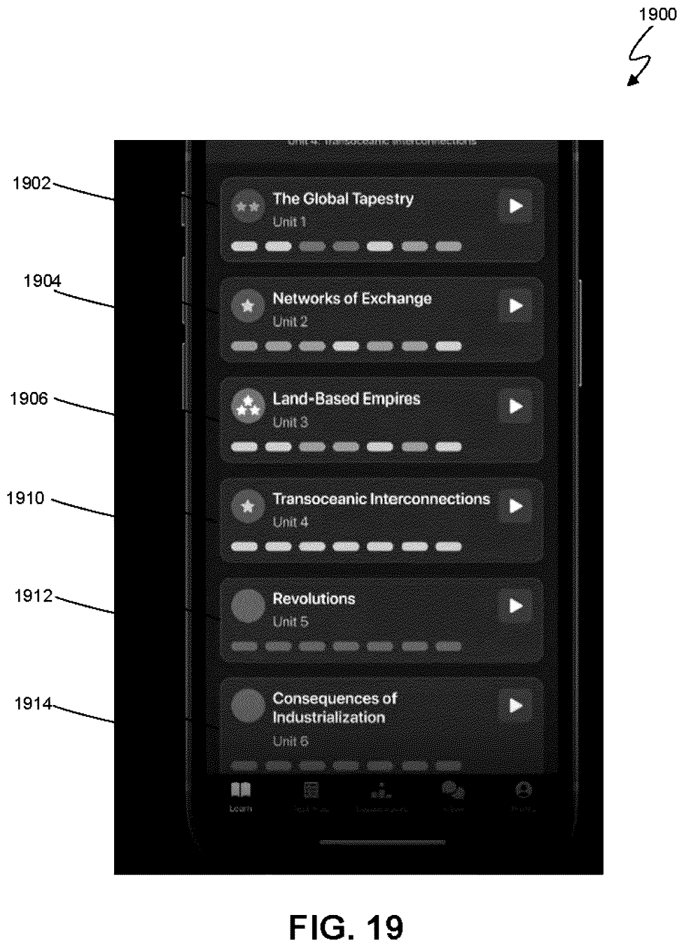

FIG. 19 depicts an exemplary view of the user interface 1900 of an online learning platform 102 which displays the mastery level of each unit when the user answers all the questions.

The user interface 1900 is accessed by the user using the online learning platform 102 installed on the user's device. The user interface 1900 displays the topic-wise and the unit-wise progress made by the user. In user interface 1900, various tabs represent the units under the subject ‘History’, in the case of the present example. Further, these units include various topics within it, the content of which when accessed and answered by the user increases the mastery level of the user in that particular topic and unit separately. For instance, tab 1902 represents ‘The Global Tapestry’, tab 1904 represents ‘Networks of Exchange’, tab 1906 represents ‘Land-based Empires’, tab 1908 represents ‘Transoceanic Interconnections’, tab 1910 represents ‘Revolutions’, tab 1912 represents ‘Consequences of Industrialization’, and so on represents the units of the ‘History’ subject.

The circle along with the star inside every unit tab indicates the mastery level of the user in that particular unit. Similarly, the cylindrical tab inside every unit tab indicates the total number of topics inside every unit. The user has to go through each topic to complete the unit. For example, the user has completed the whole unit since the cylindrical shapes are filled with dark colors but attained ⅖ stars in the first unit which means that in some areas the user is lagging and needs more attention on this topic.

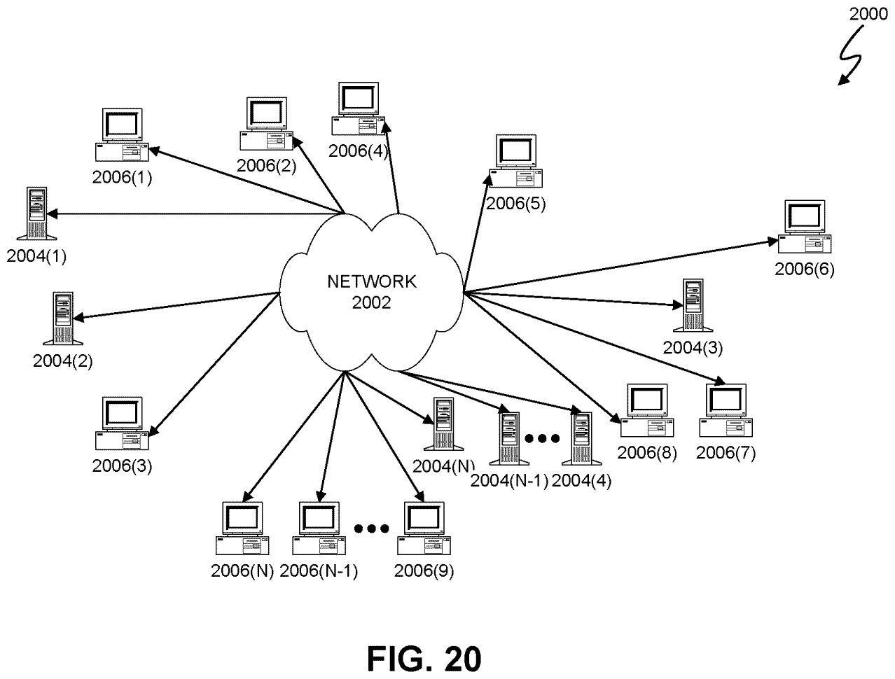

FIG. 20 is a block diagram illustrating a network environment in which a user mastery tracking system 100 and process 200 may be practiced. Network 2002 (e.g. a private wide area network (WAN) or the Internet) includes several networked server computer systems 2004(1)-(N) that are accessible by client computer systems 2006(1)-(N), where N is the number of server computer systems connected to the network. Communication between client computer systems 2006(1)-(N) and server computer systems 2004(1)-(N) typically occurs over a network, such as a public switched telephone network over asynchronous digital subscriber line (ADSL) telephone lines or high-bandwidth trunks, for example, communications channels providing TI or OC3 service. Client computer systems 20406(1)-(N) typically access server computer systems 2004(1)-(N) through a service provider, such as an internet service provider (“ISP”) by executing application-specific software, commonly referred to as a browser, on one of client computer systems 2006(1)-(N).

Client computer systems 2006(1)-(N) and/or server computer systems 2004(1)-(N) are specialized computers programmed to improve conventional computer systems to implement and utilize the user mastery tracking system 100 and process 200. The type of computer system that can be specially programmed to implement and utilize the user mastery tracking system 100 and process 200 includes a mainframe, a mini-computer, a personal computer system including notebook computers, a wireless, mobile computing device (including personal digital assistants, smartphones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the user mastery tracking system 100 and process 200 can be implemented using code stored in a tangible, non-transient computer-readable medium and executed by one or more processors. In at least one embodiment, the user mastery tracking system 100 and process 200 can be implemented completely in hardware using, for example, logic circuits and other circuits including field programmable gate arrays.

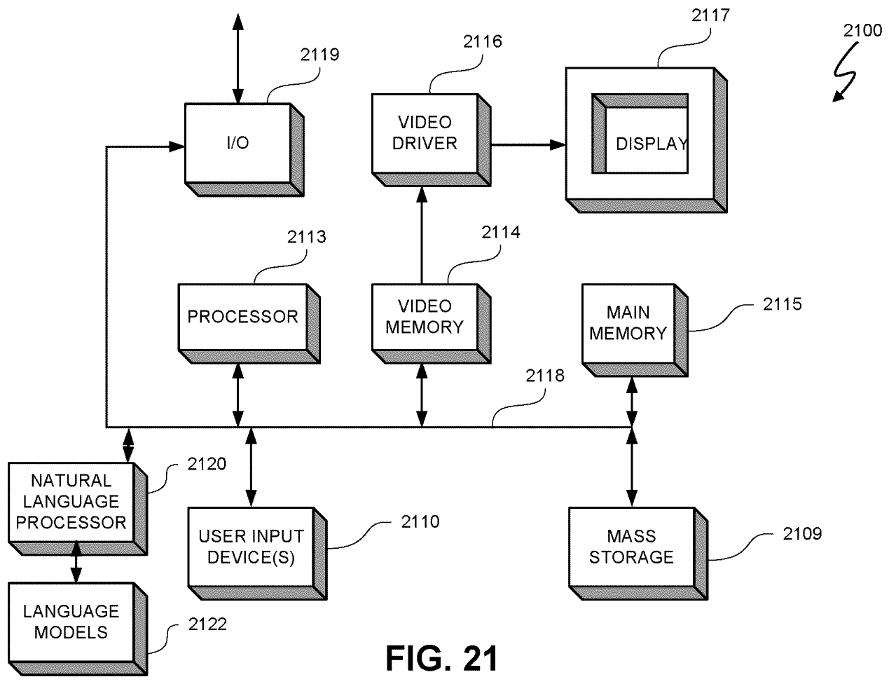

Embodiments of the user mastery tracking system 100 and process 200 can be implemented on a computer system such as a special-purpose, special-programmed computer 2100 illustrated in FIG. 21. The input user device(s) 2110, such as a keyboard and/or mouse, are coupled to a bi-directional system bus 2118. The input user device(s) 2110 are for introducing user input to the computer system and communicating that user input to processor 2113. The computer system of FIG. 21 generally also includes a non-transitory video memory 2114, non-transitory main memory 2115, and non-transitory mass storage 2109, all coupled to bi-directional system bus 2118 along with input user device(s) 2110 and processor 2113. The mass storage 2109 may include both fixed and removable media, such as a hard drive, one or more CDs or DVDs, solid state memory including flash memory, and other available mass storage technology. Bus 2118 may contain, for example, 32 of 64 address lines for addressing video memory 2514 or main memory 2115. The system bus 2118 also includes, for example, an n-bit data bus for transferring DATA between and among the components, such as CPU 2109, main memory 2115, video memory 2114, and mass storage 2109, where “n” is, for example, 32 or 64. Alternatively, multiplex data/address lines may be used instead of separate data and address lines.

I/O device(s) 2119 may provide connections to peripheral devices, such as a printer, and may also provide a direct connection to a remote server computer systems via a telephone link or to the Internet via an ISP. I/O device(s) 2119 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection, or the like. Examples of I/O devices include modems, sound and video devices, and specialized communication devices such as the aforementioned network interface.

Computer programs and data are generally stored as code in a non-transient computer-readable medium such as flash memory, optical memory, magnetic memory, compact disks, digital versatile disks, and any other type of memory. The computer program is loaded from a memory, such as mass storage 2109, into main memory 2115 for execution. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 2113, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 2115 is comprised of dynamic random access memory (DRAM). Video memory 2114 is a dual-ported video random access memory. One port of the video memory 2114 is coupled to the video amplifier 2116. The video amplifier 2116 is used to drive the display 2117. Video amplifier 2116 is well-known in the art and may be implemented by any suitable means. This circuitry converts pixel DATA stored in video memory 2114 to a raster signal suitable for use by display 2117. Display 2117 is a type of monitor suitable for displaying graphic images.

The computer system described above is for purposes of example only. The user mastery tracking system 100 and process 200 may be implemented in any type of computer system or programming or processing environment. It is contemplated that the user mastery tracking system 100 and process 200 might be run on a stand-alone computer system, such as the one described above. The user mastery tracking system 100 and process 200 might also be run from a server computer system that can be accessed by a plurality of client computer systems interconnected over an intranet network. Finally, the user mastery tracking system 100 and process 200 may be run from a server computer system that is accessible to clients over the Internet.

Although embodiments have been described in detail, it should be understood that various changes, substitutions, and alterations can be made hereto without departing from the spirit and scope of the invention as defined by the appended claims.

What is claimed is:

1. A method of tracking mastery of a user on an online learning platform to tailor the educational content delivery, the method comprising:
executing code using one or more processors of a computer system to cause the computer system to perform operations comprising:
receiving inputs from the user related to the selection of a topic that the user wants to study via the online learning platform;
presenting a set of questions to the user via a user interface, wherein the set of questions includes questions related to various educational standards related to the selected topic;
updating mastery of the user on the topic in real-time based on responses submitted by the user on presented questions, wherein the mastery is displayed to the user via a graphical representation on the user interface;
identifying educational standards within a topic where the user has a lowest mastery level by analyzing the user's mastery level across different standards within the topic in real-time to assess the current performance of the user on various standards and identify the unmastered standards;
receiving questions that are selected from the unmastered standards or standards for which the user haven't reached the next mastery threshold.

2. The method of claim 1 wherein the questions include a combination of academic, non-academic, interactive, and non-interactive.

3. The method of claim 1 wherein the questions can be multiple-choice questions, interactive simulations, fill-in-the-blanks, truth or lie, and explanatory videos to cater to different learning styles.

4. The method of claim 1 wherein receiving the questions based on the unmastered standards comprises:
identifying standards and content distribution settings;
identifying standards that are in correspondence with the user's learning needs to present the question of the corresponding unmastered standard; and
filtering and prioritizing the received content items to ensure they target the user's weakest areas.

5. The method of claim 1, wherein selecting questions to be presented further comprises:
selecting questions based on unmastered standards or standards below the next mastery threshold, aligned with predetermined content distribution settings;
prioritizing academic interactive questions to ensure comprehensive coverage and mastery; and
ensuring approximately two-thirds of questions are academic interactive, with the remaining one-third comprising varied content types.

6. The method of claim 1 wherein the user's mastery level keeps on updating in real-time based on the user's interaction with the questions.

7. The method of claim 1 wherein the fetched questions provided to the user include a mixed set of questions across all standards within a topic.

8. The method of claim 1 wherein the fetched questions are provided to the user ensures broad coverage of all standards within the topic, based on the real-time analysis.

9. The method of claim 1 wherein the user's response to each fetched question is monitored and analyzed to continuously update their mastery status on a real-time basis.

10. The method of claim 1 further comprises prioritizing the weakest area of the user comprises:
analyzing the user's performance to determine the standards with the lowest mastery level;
ranking the fetched questions based on their relevance to the identified weakest standards; and
selecting and organizing the ranked questions to ensure that those addressing the weakest areas are presented first.

11. The method of claim 1 wherein the user's mastery progress is visualized to the user using graphical representations like pie charts, and other indicators enabling users to easily track their mastery progress and identify areas where improvement is needed.

12. The method of claim 1 wherein the served question is dynamically adjusted to focus on the weaker topics as the user progresses answering questions comprising:
monitoring the user's mastery level for each standard within the topic;
identifying standards with lower mastery levels or those yet to reach the next proficiency threshold;
adjusting the question served to prioritize materials targeting the identified weaker standards; and
updating the question selection in real-time to reflect the user's evolving mastery and learning needs.

13. The method of claim 1 further includes:
providing real-time feedback to the user, wherein the feedback includes updates on the mastery level and encouragement messages to the user.

14. A system for tracking mastery of a user on an online learning platform to tailor the educational content delivery, the system comprising:
one or more processors;
memory, operatively coupled to the one or more processors consisting of one or more codes that, when executed, cause the one or more processors to perform operations comprising:
receiving inputs from the user related to the selection of a topic that the user wants to study via the online learning platform;
presenting a set of questions to the user via a user interface, wherein the set of questions includes questions related to various educational standards related to the selected topic;
updating mastery of the user on the topic in real-time based on responses submitted by the user on presented questions, wherein the mastery is displayed to the user via a graphical representation on the user interface;
identifying educational standards within a topic where the user has a lowest mastery level by analyzing the user's mastery level across different standards within the topic in real-time to assess the current performance of the user on various standards and identify the unmastered standards;
receiving questions stored in a database, wherein the questions are selected from the unmastered standards or standards that haven't reached the next mastery threshold.

15. The system of claim 14 further comprises:
a user interface integrated within the online learning platform that displays the generated question.

16. The system of claim 14 wherein the questions are provided to the user based on historical performance data of the user, thereby enhancing ability of the user to master the unmastered standard or standard with low mastery level.

17. The system of claim 14 wherein machine learning techniques are utilized to continuously improve the ability to identify and prioritize questions for the user based on ongoing performance data comprises:
identifying patterns and predicting the mastery level and learning progress of the user;
updating on a real-time basis based on the new performance of the user;
an adaptive algorithm that dynamically adjusts the selection and sequencing of educational questions based on the updated predictions of the machine learning algorithms, ensuring that the questions served are in correspondence with the user's current mastery level and learning needs; and
a feedback loop wherein the user's interactions with the served questions, including performance on questions, time spent on tasks, and engagement levels, are fed back into the machine learning module to enhance its future question generation recommendations.

18. The system of claim 14 further comprises:
a visualization module that displays visual progress indicators that include pie charts, and progress bars to the user, wherein the indicators represent the user's mastery levels across various educational standards and topics.

19. The system of claim 14 wherein the user profile is updated in real-time based on the user's performance on the provided questions, ensuring that the adaptive learning path remains current and accurate.

20. The system of claim 14 further comprises:
a feedback module configured to provide real-time feedback to the user, wherein the feedback includes updates on the mastery level and encouragement messages to the user.
